(19) United States
(12) Patent Application Publication
(10) Pub. No.: US 2008/0114507 A1
(43) Pub. Date: May 15, 2008

(54) System and method for situational control of mobile platform maintenance and operation

(76) Inventors: Robert S. Ruth, Bellevue, WA (US); Richard T. Knudson, Federal Way, WA (US)

Correspondence Address: HARNESS DICKEY & PIERCE, PLC, P.O. BOX 828, BLOOMFIELD HILLS, MI, 48303, US

(21) Appl. No.: 11/558,806

(22) Filed: Nov. 10, 2006

(51) Int. Cl. G06F 19/00

(52) U.S. Cl. 701/29; 701/3

(57) ABSTRACT

A system for managing situational events associated with a mobile platform (such as a train, ship, aircraft or automobile) is provided. The system includes an operational events module that determines if a situation regarding the mobile platform has occurred based on event input. The event input is generated by a log book, a maintenance system, a materials management system, a diagnostic system or an operations system for example. The system also includes a situational manager module that determines at least one alert based on the situation if the situation exists. The system further includes a graphical user interface module that displays the event input, the situation and the alert data to enable an operator to view the events relating to the mobile platform and determine a response to the situation if a situation exists.

### FIELD

The present disclosure relates generally to systems and methods for monitoring the operation of mobile platforms, and more particularly to a system and method for control of situational occurrences related to affecting aviation maintenance and operation of a mobile platform.

### BACKGROUND

The statements in this section merely provide background information related to the present disclosure and may not constitute prior art.

Many mobile platforms (such as trains, ships, aircraft and automobiles) require routine scheduled maintenance. Many times, the scheduled maintenance can be delayed due to problems arising from late dispatch or arrival of the mobile platform or from unexpected part shortages. In addition, unscheduled maintenance may be required on the mobile platform in response to situations arising while the mobile platform is in transit. These situations often arise in connection with the operation of commercial passenger aircraft.

Currently, present day maintenance tracking/performance systems are limited in capabilities such that they do not adequately manage either scheduled maintenance delays or unscheduled required maintenance. In addition, such systems typically are not able to alert those responsible for responding to the scheduled maintenance delays or unscheduled required maintenance immediately after the maintenance delay or unscheduled maintenance event occurs. In addition, existing systems either cannot provide, or have limited ability to provide, mining or trend analysis of past situations or past situation analysis.

Accordingly, it would be desirable to provide a system and method for control of situational occurrences affecting mobile platform maintenance and operation, in which the system is responsive to changes in planned events and changes in unplanned events to alert those responsible to respond immediately after the occurrence of the situation while also providing data mining and data analysis tools.

### SUMMARY

A system for managing situational events associated with a mobile platform is provided. The system includes an operational events module that determines if a situation regarding the mobile platform has occurred based on event input. The system also includes a situational manager module that determines at least one alert based on the situation if a situation exists. The system further includes a graphical user interface module that displays the event input, the situation and the alert data to enable an operator to determine a response to the situation if a situation exists.

In one embodiment, a method of managing the maintenance and dispatch of a mobile platform in response to an operational event is provided. The method includes receiving at least one event input regarding the mobile platform relating to at least one of a required maintenance event and an operation event. The method also includes determining if a situation exists that is associated with performing the required maintenance event or operation event, based on the received event input, and alerting at least one operator if the situation exists.

The present teachings also provide a method of managing the maintenance and dispatch of at least one mobile platform in response to an operational event. In certain examples, a commercial aircraft forms the mobile platform. The method includes receiving an event input relating to at least one of a required maintenance event and an operation event for the aircraft. The method also includes storing the event input into an operational events database, and gathering from the operational events database stored event inputs that match the received event input. The method includes matching the received event input and stored event inputs to predefined event inputs that result in situations and determining that a situation exists based on the matched combination of the received event input and the stored event inputs.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a dataflow diagram illustrating an exemplary situational control system of the present disclosure;

FIG. 2 is a dataflow diagram illustrating an operational events module for the system of FIG. 1;

FIG. 3 is a flowchart illustrating an operational sequence for the module of FIG. 2;

FIG. 4 is a flowchart illustrating an operational sequence for the situation manager module of FIG. 1;

FIG. 5 is a dataflow diagram illustrating a post situation analysis module for the system of FIG. 1; and

FIG. 6 is a flowchart illustrating an operational sequence for the module of FIG. 5.

### DETAILED DESCRIPTION

The following description is merely exemplary in nature and is not intended to limit the present disclosure, application, or uses. Although the following description is related generally to the situational control of aviation maintenance and operation for a commercial aircraft, it will be understood that the situational control architecture as described and claimed herein is applicable to any type of mobile platform (such as an aircraft, ship, spacecraft, train or land-based motor vehicle). Further, the architecture described herein can be implemented in various other applications besides aviation maintenance and operation. Therefore, it will be understood that the following discussion is not intended to limit the scope of the appended claims to only commercial aircraft or to aviation maintenance and operation applications.

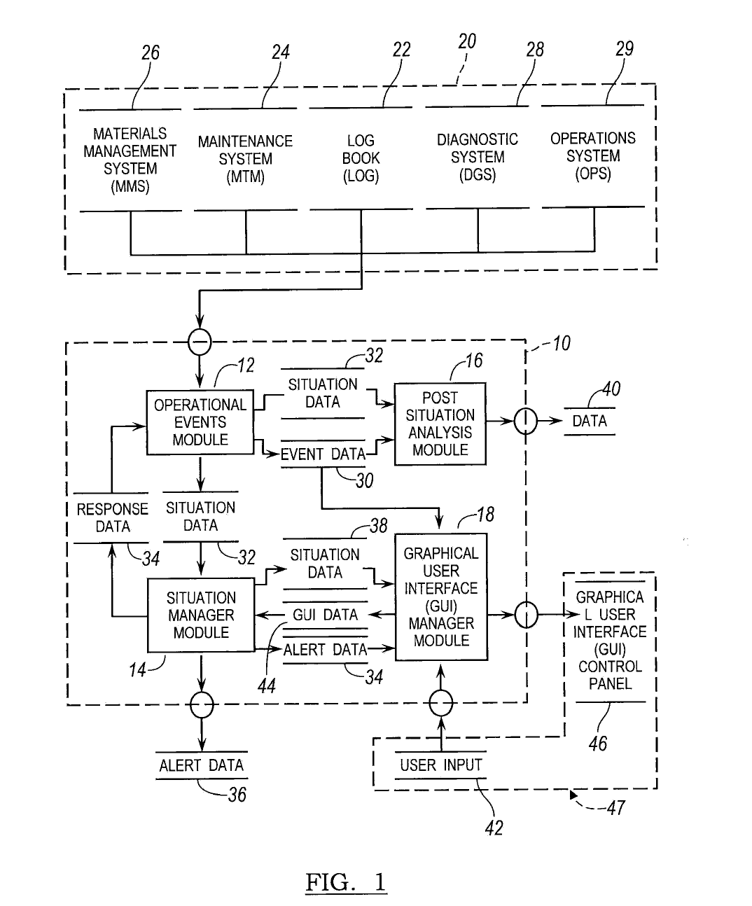

With reference to FIG. 1, a control module 10 for the situational control of aviation maintenance and operation is shown in accordance with an embodiment of the present disclosure. As used herein, the term “module” refers to an application specific integrated circuit (ASIC), an electronic circuit, a processor (shared, dedicated, or group) and memory that executes one or more software or firmware programs, to a combinational logic circuit, and/or to other suitable components that provide the described functionality. In FIG. 1, a dataflow diagram illustrates various components of a responsive situational control system that can be embedded within the control module 10. Various embodiments of the control module 10 may include any number of sub-modules embedded within the control module 10 may include any number of sub-modules embedded within the control module 10. The sub-modules shown in FIG. 1 may be combined and/or further partitioned to similarly control and manage situations affecting the maintenance and operation associated with respective aircraft(s). Inputs to the control module 10 can be received from other control modules (not shown) within the aircraft, and/or determined by other sub-modules (not shown) within the control module 10. In the embodiment illustrated in FIG. 1, the control module 10 includes an operational events module 12, a situation manager module 14, a post situation analysis module 16, and a graphical user interface (GUI) manager module 18.

The operational events module 12 receives various forms of input event data 20. The event data 20 is received from a variety of sources such as a log book (LOG) 22, a maintenance system (MTM) 24, a materials management system (MMS) 26, a diagnostic system (DGS) 28, or an operations system (OPS) 29. It should be noted that these systems could be just a few of the systems supplying event data 20 to the operational events module 12, and further, particular operators of the mobile platform may desire additional or alternative sources of event data 20. Also, while five specific types of event data 20 are illustrated, a greater or lesser plurality of distinct types of event data 20 could be accommodated by the control module 10.

The specific inputs received from the LOG 22, MTM 24, MMS 26, DGS 28, and OPS 29 will be discussed in greater detail below. Based on these inputs, operational events module 12 determines if a specific situation regarding the mobile platform has occurred and sets event data 30 and situation data 32, if a situation exists, for the post situation analysis module 16. The operational events module 12 also sets situation data 32, if a situation exists, for the situation manager module 14. The operational events module 12 also sets event data 30 for the GUI manager module 18. The operational events module 12 also receives as input response data 33 from the situation manager module 14. The situation manager module 14 receives as input the situation data 32 from the operational events module 12. Based on the situation data 32, the situation manager module 14 determines an alert in response to the situation, and sets alert data 34 and situation data 32 for the GUI manager module 18. The situation manager module 14 also outputs alert data 36 and sets response data 33 for the operational events module 12.

The post situation analysis module 16 receives as input the event data 30 and the situation data 32 from the operational events module 12. Based on the event data 30 and the situation data 32 the post situation analysis module 16 determines past responses to situations based on historical data and outputs historical, trend and anomaly data, generally termed as “data 40” for use by an external module, such as a second GUI manager module (not shown). The GUI manager module 18 receives as input the alert data 34 and the situation data 32 from the situation manager module 14, and the event data 30 from the operational events module 12. The GUI manager module 18 also receives as input user input 42. Based on these inputs, the GUI manager module 18 displays the event data 30 and the situation data 32 to enable an operator to determine a response to the situation and sets GUI data 44 and GUI control panel 46. The GUI control panel 46 and the user input 42 can collectively be viewed as forming a graphical user interface subsystem 47 of the control module 10.

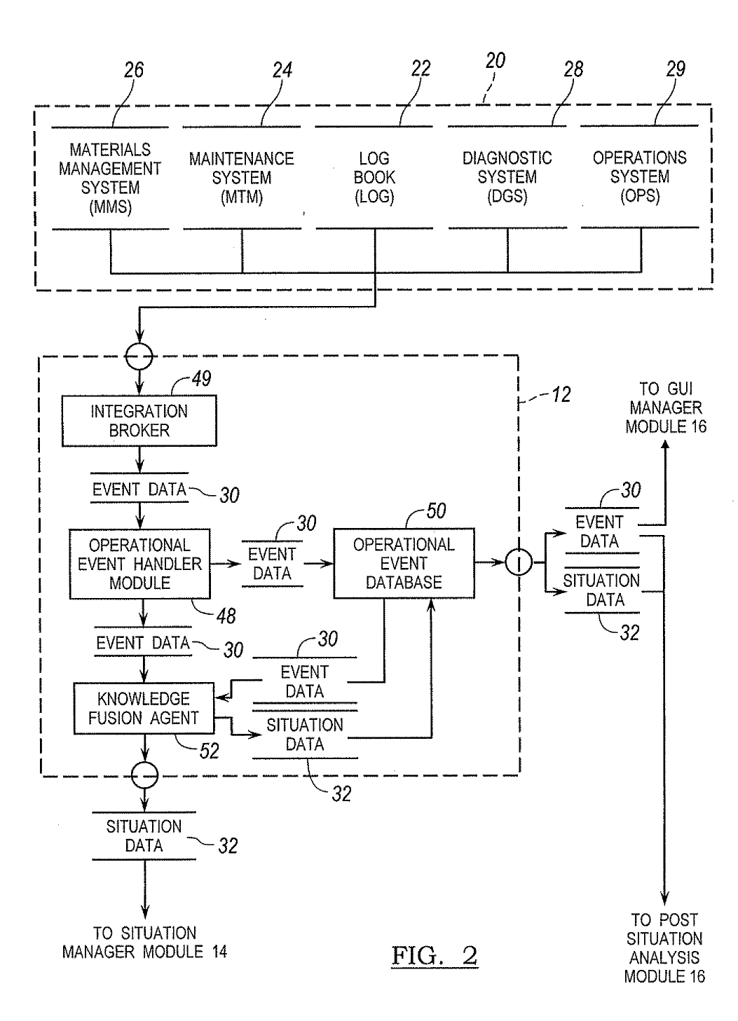

With reference now to FIG. 2, a dataflow diagram illustrates one exemplary embodiment of an operational event handler system that can be embedded within the operational events module 12. In this embodiment, the operational events module 12 includes an integration broker 49, an operational event handler module 48, an operational event database 50, and a knowledge fusion agent 52.

The integration broker 49 integrates the various types of event data 20 received from the LOG 22, MTM 24, MMS 26, DGS 28 and OPS 29 and translates this event data 20 into event data 30 such that the event data 30 received can be used by operational event handler module 48. The integration broker 49 can also filter unnecessary information out of the event data 20 received from the LOG 22, MTM 24, MMS 26, DGS 28 and OPS 29 to provide the operational event handler module 48 with only the event data 30 needed to determine if a situation exists, as will be discussed herein. An exemplary integration broker 49 is the WEBSPHERE™ Process Server, manufactured by IBM of Armonk, N.Y.

The event data 20 received from the LOG 22 comprises a pilot reported error, an actual departure time of the mobile platform, and an actual arrival time of the mobile platform, for example. As the LOG 22 is coupled to the mobile platform, the LOG 22 can also provide event data 20 regarding the condition of the mobile platform and the subsystems of the mobile platform. The MTM 24 provides event data 20 to the integration broker 49 that includes a scheduled maintenance event and duration of the maintenance event, for example. The MTM also provides event data 20 including maintenance schedules, maintenance actions performed and maintenance performance release. These are planned, actual events for the mobile platform. It should be noted that an exemplary MTM 24 is Maintenix, which is commercially available from MXI Technologies of Ottawa, Canada, however, any suitable asset management system could be used.

The MMS 26 also provides event data 20 that includes planned and actual movement of mobile platform component parts. The MMS 26 provides event data 20 that comprises, for example, an expected wait time for receiving a part required for maintenance. The event data 20 can also include notification of part shortages, and the late delivery of parts, for example. The DGS 28 is coupled to the mobile platform and provides event data 20 that includes an array of various sensed conditions on the mobile platform, such as engine cooling problems, performance indicators, such as whether a component is performing within normal operational parameters and/or outside of normal operational parameters, and the like. The OPS 29 comprises a system that plans and schedules routes for the mobile platform. The OPS 29 is generally ground based and may be in communication with the mobile platform. The OPS 29 provides event data 20 that includes the planned flight schedules, planned routes and general schedule for the mobile platform. The event data 20 can also include actual flight route and schedule for the mobile platform. Thus, the OPS 29 can provide event data 20 indicative of an accomplishment and/or deviation from the planned flight route and schedule.

The operational event handler module 48 receives as input event data 30 from the integration broker 49. Based on the event data 30 received, the operational event handler module 48 sets event data 30 for the operational event database 50 and the knowledge fusion agent 52. The operational event handler module 48 can receive an event ID back from the operational event database 50 after the operational event database 50 receives the event data 30, and/or the operational event handler module 48 could set an event ID for the knowledge fusion agent 52 depending upon the desired implementation of the operational event database 50.

The operational event database 50 receives as input the event data 30 from the operational event handler module 48, and the situation data 32 and the response data 33 from the situation manager module 14 (FIG. 1). The operational event database 50 stores the event data 30, situation data 32 and response data 33. Generally, the operational event database 50 holds the event data 30 for a short time, until the event data 30 is no longer needed to maintain awareness and response to unplanned events. The operational event database 50 sets as output event data 30 and situation data 32. The event data 30 is subsequently received by the GUI manager module 18, and both the event data 30 and situation data 32 are received by the post situation analysis module 16, as will be discussed herein.

With continued reference to FIG. 2, the knowledge fusion agent 52 receives the event data 30 from the operational event handler module 48. The knowledge fusion agent 52 can receive a situation ID back from the operational event database 50 after the operational event database 50 receives the situation data 32, and/or the knowledge fusion agent 52 could output a situation ID to the GUI manager module 18, depending upon the desired implementation. It should be noted that although one knowledge fusion agent 52 is illustrated, the operational events module 12 could employ numerous knowledge fusion agents 52. Therefore, as used herein, knowledge fusion agent 52 can denote at least one or a plurality of knowledge fusion agents 52. The knowledge fusion agent 52, based on the event data 30, determines if a situation exists, and sets situation data 32 for the operational event database 50 if a situation is determined to exist, as will be discussed. The knowledge fusion agent 52 also outputs the situation data 32 to the situation manager module 14.

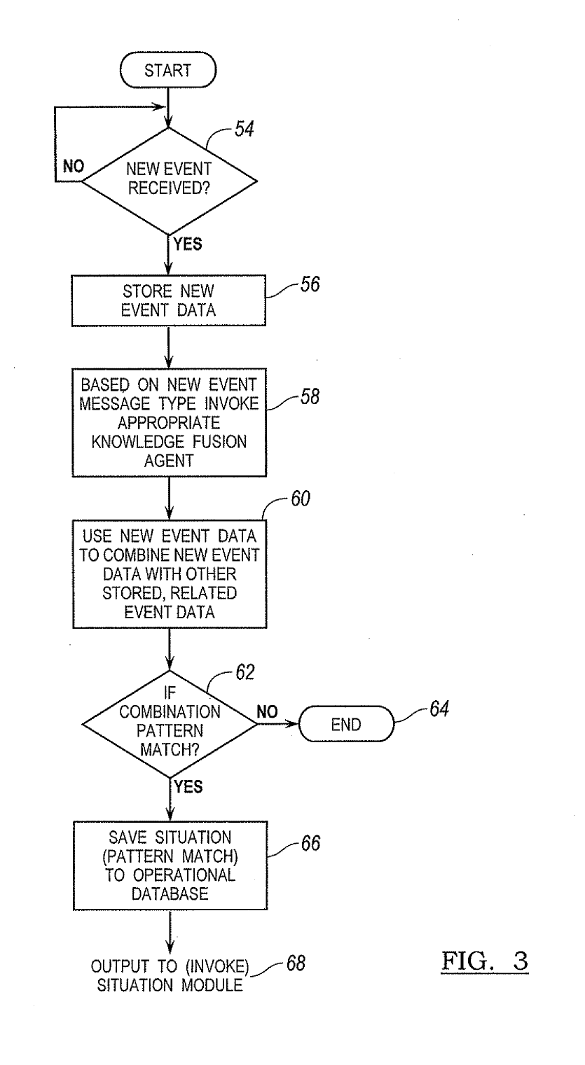

With reference to FIG. 3, a process flow diagram illustrates an exemplary operational sequence performed by the operational events module 12. In operation 54, a determination is made if event data 20 has been received by the integration broker 49 from at least one of the LOG 22, MTM 24, MMS 26, DGS 28 and/or OPS 29. If no event data 20 has been received, then operation 54 is repeated until a response is received. If event data 20 is received at operation 54, then the event data 30 is stored in the operational event database 50 at operation 56. Then, the event data 30 is classified. The event data 30, in this example, is classified into one of two categories: information only, or situation. In order to classify the event data 30, in operation 58, based on the received event data 30, the operational event handler module 48 invokes the appropriate knowledge fusion agent 52. Due to the variety of types of event data 30 that can be received by the operational event handler module 48, specific knowledge fusion agents 52 can be assigned to respond to or analyze particular types of event data 30.

Then, in operation 60, the knowledge fusion agent 52 gathers, based on the received event data 30, related stored event data 30 from the operational event database 50 to combine the new event data 30 with the related stored event data 30 to generate a rich understanding of the context surrounding the new event data 30. For example, if the new event data 30 comprises a new time of arrival, the particular knowledge fusion agent 52 can gather, from the operational event database 50, the stored event data 30 related to the mobile platform, such as the scheduled arrival time, the next scheduled departure time for that mobile platform and/or the time of scheduled maintenance for the mobile platform.

Then, in operation 62, the knowledge fusion agent 52 determines if the combination of the new event data 30 and the stored event data 30 matches a predefined pattern of event data 30 that results in a situation. If the received event data 30 and the stored event data 30 does not match a pattern, then the method ends at operation 64. Otherwise, if the combination matches one of the predefined patterns of event data 30, then the combination is stored as situation data 32 in the operational event database 50 in operation 66.

Thus, with reference back to the prior example, if the new received event data 30 comprises a new time of arrival and the stored event data 30 includes such event data 30 as a next scheduled departure time for that mobile platform that is within a predefined proximity of time to the new time of arrival, such that due to the late arrival time the mobile platform will be late in its next departure, the knowledge fusion agent 52 recognizes this pattern of event data 30 as a situation and saves this aggregation of event data 30 as situation data 32. Further, for example, if the new event data 30 received is a new scheduled departure time, and the stored event data 30 includes scheduled maintenance for the mobile platform and a completion time for the maintenance, the knowledge fusion agent 52 will save the aggregated event data 30 as situation data 32 if the completion time for the maintenance is after or within a threshold of the scheduled departure time for the mobile platform. Then, in operation 68, the situation data 32 is outputted to invoke the situation manager module 14.

With reference now to FIG. 1, the situation manager module 14 is illustrated. The situation manager module 14 receives as input the situation data 32 from the operational events module 12 and the GUI data 44. Based on the situation data 32, the situation manager module 14 invokes a workflow to handle the situation, as will be discussed. The workflow can include identifying a particular responsible handler for the situation described in the situation data 32. The workflow invoked by the situation manager module 14 sets alert data 34 for the GUI manager module 18 and can output alert data 36 to notify the responsible handler of the situation.

Then, from the GUI data 44 received by the situation manager module 14, which can comprise a response to the situation received from the responsible handler, the situation manager module 14 sets response data 33 for the operational events module 12. The response data 33 comprises data regarding the response to the situation data 32, as provided by the responsible handler through the GUI control panel 46. The operational event database 50 stores the situation data 32 and response data 33 until the situation is complete, and holds increasingly thorough links and modifications to the data received through the situation manager module 14 from the GUI data 44, to reflect an increasingly thorough or accurate understanding of the situations. All of the response data 33 is integrated with the situation data 32 by the operational event database 50 and output as situation data 32 to the post situation analysis module 16 and optionally, to the GUI manager module 18 (not shown).

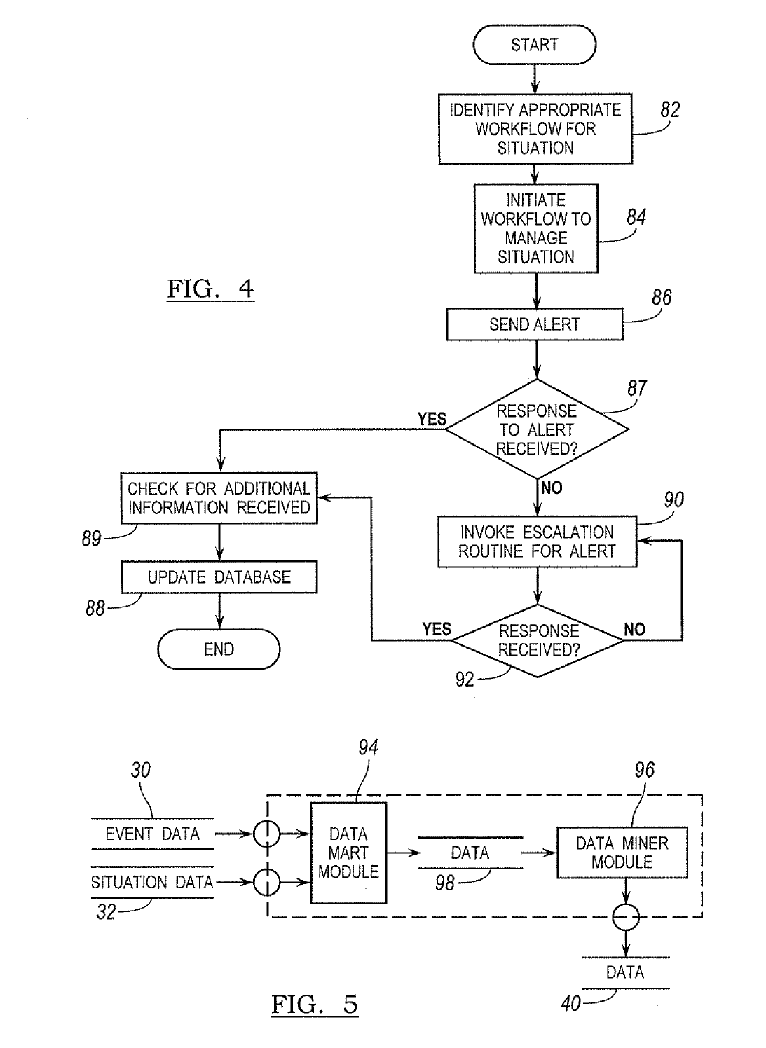

In particular, with reference to FIG. 4, a process flow diagram illustrates in greater detail an operational sequence performed by the situation manager module 14. In operation 82, based on the situation data 32 a workflow is identified to handle the situation. The workflow can consist of scheduling and delegation of tasks, which can be performed by any appropriate commercially available workflow tool. Then, in operation 84, the workflow is initiated to manage the situation. In operation 86, an alert is sent by the workflow to at least one responsible handler. The alert can comprise a text message to a display device, such as a pager, PDA, or GUI control panel 46, a display message on the GUI control panel 46 (alert data 34), PDA (alert data 36), or other device, or an audible message, such as a recorded message transmitted to the GUI control panel 46 (alert data 34) or telephone (alert data 36).

In operation 87, if a response to the alert is received from the handler, then in operation 89, a check is made to see if additional information has been received from the GUI manager module 18 as GUI data 44 regarding the situation. Then, in operation 88, the operational event database 50 is updated with the response data 33 that includes information that a response has been received, the action taken in response to the situation, and any new information regarding the situation or modifications to the situation data 32, for example.

Otherwise, if no response has been received regarding the alert in operation 87, then in operation 90, an escalation routine is invoked for the alert. The escalation routine is preferably a programmed routine that involves sending the alert data 34, 36 to the next, higher-level handler responsible for responding to the situation based on an organizational chart or for example. Alternatively, the escalation routine could send the alert data 34, 36 in a different format than the first message, for example if the first message was a display message on the GUI control panel 46 (alert data 34), the escalation routine could output a next, higher-level message, such as a text message to a pager of the responsible handler prior to contacting the next higher-level handler. Then, in operation 92, a determination is made if a response has been received. If no response has been received, then operation 90 is repeated. If a response has been received, then operation 87 is performed.

With reference now to FIG. 5, the post situation analysis module 16 is illustrated in greater detail. In FIG. 5, an exemplary dataflow diagram illustrates an embodiment of post situation analysis system that can be embedded within the post situation analysis module 16. The post situation analysis module 16 may include a data mart module 94 and a data miner module 96. The data mart module 94 receives as input the event data 30 and situation data 32 from the operational events module 12 and sets data 98 for the data miner module 96. The data mart module 94 acts as a data warehouse for storing data for use by the data miner module 96. The data miner module 96 receives the data 98 and outputs data 40. The data miner module 96 outputs the data 40 to enable a user to view trends, anomalies and/or historical responses to the same or similar situations. This data 40 can then be used by the user to determine additional knowledge fusion agents 52 if desired.

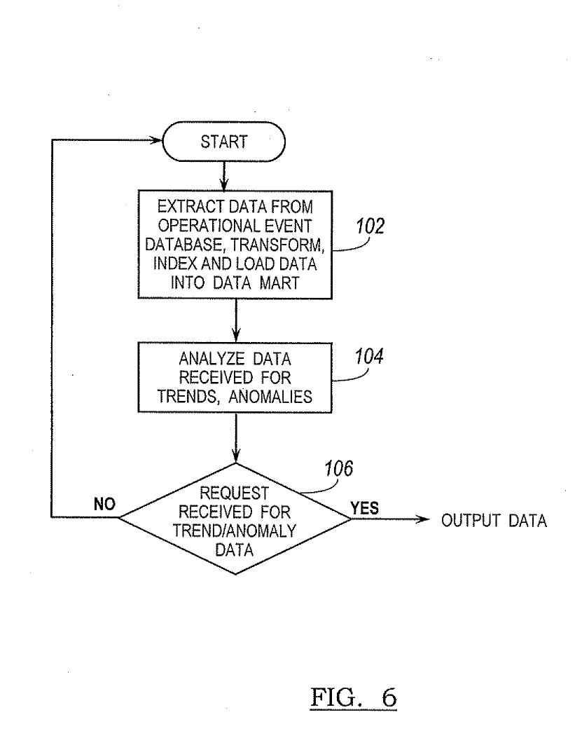

With reference to FIG. 6, a process flow diagram illustrates an exemplary operational sequence performed by the post situation analysis module 16. In operation 102, the data mart module 94, the data mart module 94 extracts the event data 30 and situation data 32 from the operational event database 50 and then transforms indexes, and loads the received event data 30 and situation data 32. Then, in operation 104, the data miner module 96 analyzes the received event data 30 and situation data 32 for trends or anomalies. In operation 106, if a request is received for data 40, then the data 40 is outputted to the requested module (not shown). After the data 40 is outputted, or if no data 40 is requested, operation 104 is repeated.

With reference back to FIG. 1, the GUI manager module 18 displays the event data 30, situation data 32 and alert data 34 on the GUI control panel 46. The GUI control panel 46 can be any suitable graphical user interface, and can comprise any number of graphical user interfaces to display the event data 30, situation data 32 and alert data 34 for an operator. Generally, the GUI control panel 46 creates a graphical user interface from which the operator can, after receiving the alert data 34, review the event data 30 and situation data 32 to determine an appropriate response to the situation. The response to the situation is entered by the operator as the user input 42, and is set by the GUI manager module as GUI data 44 for the situation manager module 14. Further detail regarding the GUI manager module 18 and the GUI control panel 46 is outside the scope of the current disclosure, but is disclosed in greater detail in pending commonly assigned U.S. patent application Ser. No. 11/456,418, entitled “Methods and Systems for Real-Time Enhanced Situational Awareness,” which is incorporated by reference herein in its entirety. In addition, greater detail is also disclosed in pending commonly assigned U.S. patent application Ser. No. 11/548,619, entitled “Methods and Systems for Aircraft Departure Enhanced Situational Awareness and Recovery,” which is incorporated by reference herein in its entirety.

Thus, upon the receipt of new event data 30 from the integration broker 49, the operational event handler module 48 can save this event data 30 into the operational event database 50 (FIG. 2). Then, the knowledge fusion agent 52 can be invoked by the operational event handler module 48 to determine, based on the saved event data 30 received from the operational event database 50, if the new event data 30 is a situation. If the new event data 30 is not a situation, then the new event data 30 is saved as event data 30 in the operational event database 50 and can later be output to both the post situation analysis module 16 and the GUI manager module 18.

If the knowledge fusion agent 52 has determined that the new event data 30 represents a situation, the new event data 30 and stored event data 30 are saved as situation data 32 in the operational event database 50. Then, the situation data 32 is outputted to the situation manager module 14. Upon receipt of the situation data 32, the situation manager module 14 can initiate a workflow for handling the received situation data 32 (FIG. 4). The workflow identifies the responsible handler for responding to the situation and can set alert data 34, 36 for the responsible handler. If a response is received via the user input 42 to the GUI manager module 18, then the response is outputted as response data 33 to the operational event database 50. If no response is received, then the situation manager module 14 invokes an escalation routine to notify the next higher responsible handler of the situation. If no response is received from the next higher responsible handler, then the situation manager module 14 continues the escalation routine. Otherwise, the received response is stored as response data 33 in the operational event database 50.

During the performance of the control module 10, external modules can access the post situation analysis module 16 to receive trend, anomaly and historical data (FIG. 6). The trend, anomaly and historical data can be compiled by the data miner module 96 based on the event data 30 and situation data 32 stored in the data mart module 94.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications can be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this disclosure, but that the scope of the present disclosure will include any embodiments falling within the foregoing description and the appended claims.

1. A system for managing situational events associated with a mobile platform comprising:
an operational events module that determines if a situation regarding the mobile platform has occurred based on event input;
a situational manager module that determines at least one alert based on the situation if a situation exists; and
a graphical user interface module that displays the event input, the situation and the alert data to enable an operator to view the events relating to the mobile platform and to determine a response to the situation if a situation exists.

2. The system of claim 1, wherein the operational events module further comprises:
an integration broker that receives the event input and transforms the event input into event data;
an operational event handler module that receives the event data; and
an operational event database receives the event data from the operational event handler module and that stores the event data to provide stored event data regarding the operation of the mobile platform.

3. The system of claim 2, wherein the operational events module further comprises:
a knowledge fusion agent that determines if the event data is a situation based on the event data and the stored event data from the operational event database, and if the event data is a situation, stores the event data as situation data in the operational event database.

4. The system of claim 3, wherein the knowledge fusion agent is invoked by the operational event handler based on the type of event data received.

5. The system of claim 3 wherein the situation manager module further comprises:
a situation manager that determines an alert based on the situation data, and that determines a workflow to manage the situation data.

6. The system of claim 5, wherein the alert is selected from the group comprising: a text notification, a visual notification, an audible notification or combinations thereof.

7. The system of claim 3 further comprising a post situation analysis module that analyzes the event data and the situation data received from the operational events module and includes:
a data mart that stores the event input and situation event received from the operational event database; and
a data miner module that determines trend data and anomaly data based on the data stored in the data mart.

8. The system of claim 1, further comprising at least one of a log book that generates the event input, a maintenance system that generates the event input, a materials management system that generates the event input, a diagnostic system that generates the event input, an operations system that generates the event input and combinations thereof.

9. A method of managing the maintenance and operation of a mobile platform in response to an operational event comprising:
receiving at least one event input regarding the mobile platform relating to at least one of a required maintenance event and an operation event;
determining if a situation exists that is associated with performing the required maintenance event or operation event, based on the received event input; and
alerting at least one operator if the situation exists.

10. The method of claim 9, further comprising:
storing the event input in an operational event database to provide stored event data associated with the operation of the mobile platform; and
determining if the received event input is a situation based on a combination of the received event input and the stored event data.

11. The method of claim 10, wherein determining if the event input is a situation further comprises:
comparing the combination of event input and stored event data to known event data patterns that result in situations;
determining that a situation exists if the event input and stored event data match a known event data pattern; and
storing the situation in the operational event database.

12. The method of claim 9, wherein alerting at least one operator if a situation exists further comprises:
transmitting at least one of a text message, audible message or visual message including data regarding the situation;
awaiting a response; and
transmitting at least one of a second text message, audible message or visual message if there is no response.

13. The method of claim 7, further comprising:
transferring the data stored in the operational event database to a data mart;
analyzing the data in the data mart for at least one of historical data, trend data and anomaly data; and
outputting at least one of the historical data, the trend data and anomaly data.

14. The method of claim 12, wherein alerting at least one operator further comprises:
initiating a workflow operation to manage the situation.

15. The method of claim 9, wherein receiving at least one event input further comprises at least one of:
receiving an event input from a log book indicative of at least one of a pilot reported error, an actual departure time of the mobile platform, and an actual arrival time of the mobile platform;
receiving an event input from a maintenance system indicative of a scheduled maintenance event;
receiving an event input from a materials management system indicative of a time to receive a component required for the scheduled maintenance event;
receiving an event input from a diagnostic system indicative of a sensed condition of the mobile platform requiring maintenance; and
receiving an event input from an operations system indicative of a scheduled route plan for the mobile platform.

16. A method of managing the maintenance and operation of at least one aircraft in response to an operational event comprising:
receiving an event input relating to at least one of a required maintenance event and an operation event for the aircraft;
storing the event input into an operational events database;
gathering from the operational events database stored event inputs that match the received event input;
matching the received event input and stored event inputs to predefined event inputs that result in situations; and
determining that a situation exists based on the matched combination of the received event input and the stored event inputs.

17. The method of claim 16, further comprising:
storing the situation event in the operational events database.

18. The method of claim 16, further comprising:
transmitting at least one of a text message, audible message or visual message including data regarding the situation;
awaiting a response; and
transmitting at least one of a second text message, audible message or visual message if there is no response.

19. The method of claim 17, further comprising:
transferring the data stored in the operational events database to a data warehouse;
analyzing the data in the data warehouse for at least one of historical data, trend data and anomaly data; and
outputting at least one of the historical data, trend data, and the anomaly data.

20. The method of claim 16, wherein receiving the plurality of event inputs further comprises at least one of:
receiving an event input from a log book indicative of at least one of a pilot reported error, an actual departure time of the aircraft, and an actual arrival time of the aircraft;
receiving an event input from a maintenance system indicative of a scheduled maintenance event;
receiving an event input from a materials management system indicative of a time to receive a component required for the scheduled maintenance event;
receiving an event input from an aircraft diagnostic system indicative of a sensed condition of the aircraft requiring maintenance; and
receiving an event input from an operations system indicative of a scheduled route plan for the mobile platform.
